(19) United States
(12) Patent Application Publication
(10) Pub. No.: US 2025/0279616 A1
(43) Pub. Date: Sep. 4, 2025

(54) CONNECTOR

(71) Applicant: Yazaki Corporation, Tokyo (JP)

(72) Inventors: Hideki SAITO, Shizuoka (JP); Takuya Hasegawa, Shizuoka (JP); Kazuya Terao, Shizuoka (JP)

(73) Assignee: Yazaki Corporation, Tokyo (JP)

(21) Appl. No.: 19/037,574

(22) Filed: Jan. 27, 2025

(30) Foreign Application Priority Data
Mar. 4, 2024 (JP) 2024-031909

(51) Int. Cl. H01R 13/639; H01R 13/627

(52) U.S. Cl. CPC H01R 13/639; H01R 13/6273

(57) ABSTRACT

A connector includes a housing configured to form an assembling space along a connection direction, and a position assurance member to be inserted into the assembling space and assembled to the housing in such a manner as to be movable along the connection direction from a tentative lock position to a regular lock position, in which the assembling space is formed between two side walls formed in the housing and extending in the connection direction, the housing includes a lock member that engages with the position assurance member assembled to the assembling space, and locks the position assurance member at the regular lock position, the lock member includes an installation portion installed between the two side walls, and the installation portion is connected to the two side walls, and connected to a columnar portion extending from a floor portion of the assembling space, to be supported at three points.

### CROSS-REFERENCE TO RELATED APPLICATION(S)

The present application claims priority to and incorporates by reference the entire contents of Japanese Patent Application No. 2024-031909 filed in Japan on Mar. 4, 2024.

### BACKGROUND OF THE INVENTION

### 1. Field of the Invention

The present invention relates to a connector.

### 2. Description of the Related Art

As a technique related to connectors, there has been conventionally known a connector that is a connector connected to a counterpart connector, and has a connector position assurance function, as described in JP 2017-157454 A, for example. This connector includes a position assurance member that assures a fitted state with the counterpart connector. The position assurance member is attached to a housing of the connector, and arranged at a standby position. After the connector and the counterpart connector are fitted with each other, the position assurance member is moved in a fitting direction, and moved from the standby position to a fitting lock position. If the position assurance member can be moved to the fitting lock position, it is assured that the connector and the counterpart connector are appropriately fitted with each other.

The above-described connector includes a portion in which the housing and the position assurance member are engaged, and the mechanical strength of this engaged portion sometimes becomes lower as compared with other portions. Thus, the development of a connector that can achieve improvement in strength has been demanded.

### SUMMARY OF THE INVENTION

In view of the foregoing, the present invention aims to provide a connector that can achieve improvement in strength.

In order to achieve the above mentioned object, a connector according to one aspect of the present invention includes a housing configured to be connectable to a counterpart connector, and form an assembling space along a connection direction; and a position assurance member to be inserted into the assembling space and assembled to the housing in such a manner as to be movable along the connection direction from a tentative lock position to a regular lock position, wherein the assembling space is formed between two side walls formed in the housing and extending in the connection direction, the housing includes a lock member that engages with the position assurance member assembled to the assembling space, and locks the position assurance member at the regular lock position, the lock member includes an installation portion installed between the two side walls, and the installation portion is connected to the two side walls, and connected to a columnar portion extending from a floor portion of the assembling space, to be supported at three points.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a connector according to an embodiment;

FIG. 2 is a perspective view of a connector according to an embodiment;

FIG. 3 is a plan view of a disassembled state of a connector according to an embodiment;

FIG. 4 is a perspective view of a housing in a connector according to an embodiment;

FIG. 5 is an explanatory diagram of a regularly-locked state of a position assurance member of a connector according to an embodiment;

FIG. 6 is an explanatory diagram of connection in a connector according to an embodiment; and

FIG. 7 is an explanatory diagram of mechanical strength in a connector according to an embodiment.

### DETAILED DESCRIPTION OF THE PREFERRED EMBODIMENTS

An embodiment according to the present invention will be described in detail below based on the drawings. In addition, the present invention is not limited by the embodiment. Further, components in the following embodiment include the ones that can be replaced by those skilled in the art, and are easy, or the ones that are substantially identical.

### Embodiment

The present embodiment relates to a connector. In the following description, among a first direction, a second direction, and a third direction that intersect with each other, the first direction will be referred to as a “connection direction X”, the second direction will be referred to as a “width direction Y”, and the third direction will be referred to as a “height direction Z”. Here, the connection direction X, the width direction Y, and the height direction Z are orthogonal to each other. The connection direction X corresponds to a connection direction or a fitting direction of a connector and a counterpart connector. The width direction Y corresponds to a width direction of a connector. The width direction Y and the height direction Z correspond to an orthogonal direction orthogonal to the connection direction X. Further, each direction to be used in the following direction refers to a direction in a state in which components are assembled to each other, unless otherwise specified. In addition, orthogonal here includes an approximately orthogonal state.

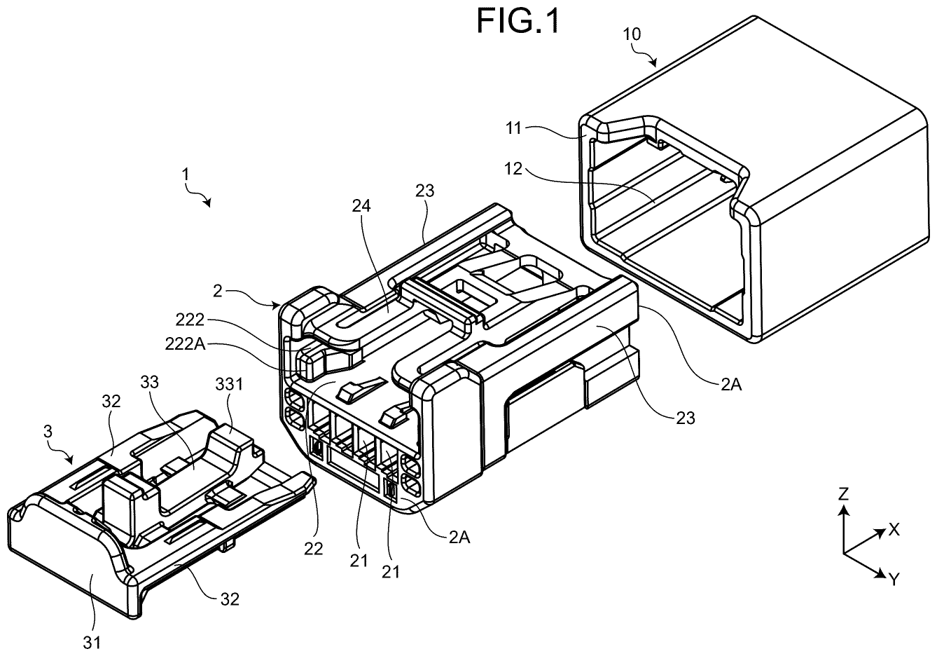

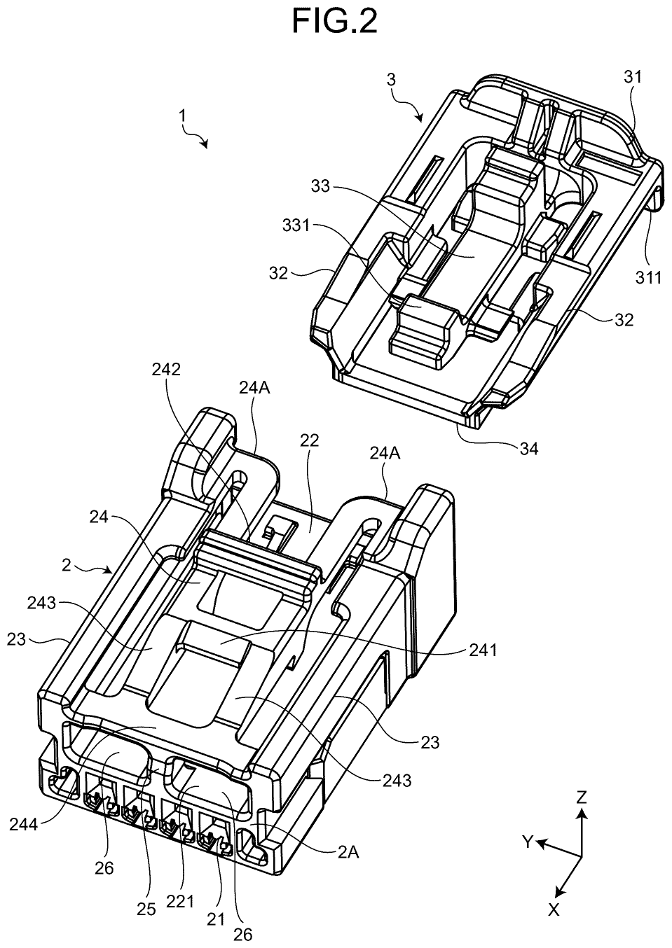

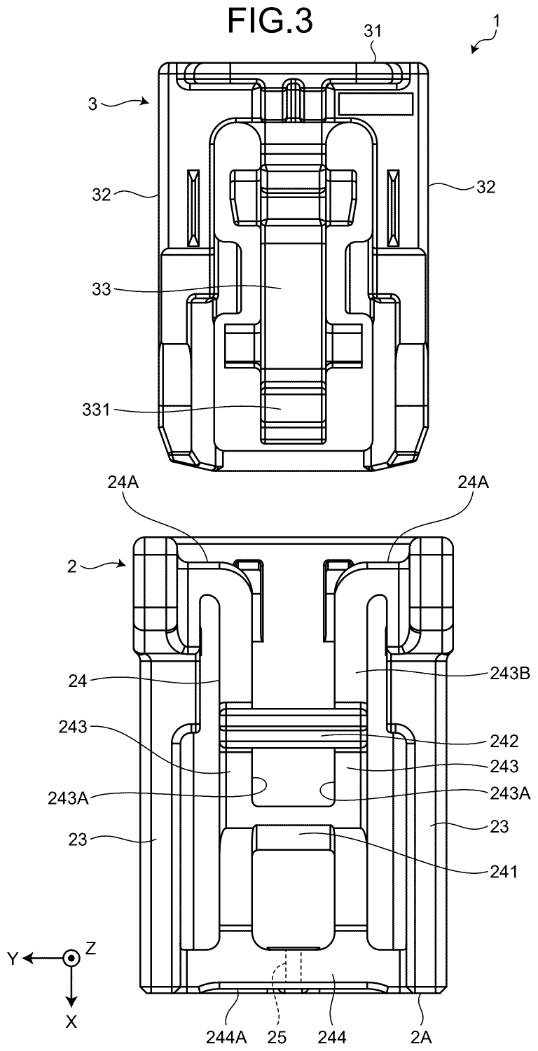

As illustrated in FIGS. 1 to 3, a connector 1 according to the present embodiment is a connector to be used with being connected to a counterpart connector 10, and has a connector position assurance (CPA) function. The connector 1 includes a housing 2 and a position assurance member 3. FIG. 1 illustrates a state in which the connector 1 and the counterpart connector 10 are separated, and the housing 2 and the position assurance member 3 are separated. The housing 2 is a member to be fitted with the counterpart connector 10, and is formed in a block shape, for example. The housing 2 is made of resin, for example, and is formed by resin molding. In the housing 2, an installation hole 21 for arranging a terminal is formed. The installation hole 21 is formed along the connection direction X with the counterpart connector 10. A plurality of installation holes 21 is formed, and the plurality of installation holes 21 is arrayed toward the width direction Y, for example. The installation hole 21 is formed with penetrating through the housing 2 toward the connection direction X, and a terminal of an electric wire (not illustrated) equipped with a terminal is inserted thereinto and held therein.

In the housing 2, an assembling space 22 is formed above a region in which the installation hole 21 is formed. The assembling space 22 is a space for inserting and assembling the position assurance member 3, and is formed between two side walls 23 provided with being separated in the width direction Y of the housing 2, for example. The side walls 23 are wall members respectively provided at ends in the width direction Y of the housing 2, and extending in the height direction Z and the connection direction X. In other words, the two side walls 23 define the assembling space 22 by partitioning side portions on both sides of the assembling space 22.

A guide portion 222 is formed in the assembling space 22. The guide portion 222 is formed at a position at a lower end of the assembling space 22 along the connection direction X. For example, the guide portion 222 is formed with protruding from the inner surfaces of the side walls 23 in the width direction Y. When the position assurance member 3 is assembled, the guide portion 222 guides the position assurance member 3 along the connection direction X. Further, the guide portion 222 functions as a stopper at the time of assembly of the position assurance member 3. For example, an end surface 222A of the guide portion 222 that is on the opposite side of a fitting surface 2A comes into contact with the position assurance member 3 at the time of assembly of the position assurance member 3, and arranges the position assurance member 3 at a regular lock position. The fitting surface 2A is an end surface of the housing 2 in the connection direction X, and is a surface facing the counterpart connector 10 in a state in which the housing 2 is fitted with the counterpart connector 10.

The housing 2 is provided with a lock member 24. The lock member 24 is a member that locks the housing 2 with respect to the counterpart connector 10 when the connector 1 and the counterpart connector 10 are connected, and is a member that engages with the position assurance member 3. The lock member 24 is provided in the assembling space 22, for example, and is installed along the connection direction X.

The lock member 24 includes a locked portion 241, a press portion 242, an arm portion 243, and an installation portion 244. The locked portion 241 is a portion that engages with a lock portion 121 of the counterpart connector 10 and a lock portion 331 of the position assurance member 3. The press portion 242 is a portion that releases locking of the locked portion 241 and the lock portion 121 by being pressed, and releases a lock state of the counterpart connector 10 and the housing 2. The locked portion 241, the press portion 242 and the installation portion 244 each extend in the width direction Y intersecting with the connection direction X, and are respectively connected to two arm portions 243, for example. The two arm portions 243 are arranged with being separated in the width direction Y, and each extend in the connection direction X. The locked portion 241, the press portion 242, and the installation portion 244 are installed between the two arm portions 243, and are arranged in the order of the installation portion 244, the locked portion 241, and the press portion 242 from the fitting surface 2A side.

The locked portion 241 is provided between facing surfaces 243A of the two arm portions 243, for example. The press portion 242 is provided with protruding upward toward the height direction Z as compared with the locked portion 241, and connected to a top surface 243B of the two arm portions 243, for example. The installation portion 244 is connected to the ends of the two arm portions 243 on the fitting surface 2A side. The installation portion 244 is formed to be longer than a distance between the two arm portions 243, and ends on both sides are connected to the side walls 23. A columnar portion 25 is connected to a central position in the width direction Y of the installation portion 244. The columnar portion 25 is a member extending along the height direction Z, and is provided between the installation portion 244 and a floor portion 221 of the assembling space 22. The columnar portion 25 supports the installation portion 244 from below. More specifically, the lock member 24 is supported at three points on the fitting surface 2A side, and strength is improved. In other words, the lock member 24 is supported by the two side walls 23 and the columnar portion 25 on the fitting surface 2A side through the installation portion 244, and has a structure less likely to be broken even if external force is received. For example, if the installation portion 244 is supported by the two side walls 23 at two points, the installation portion 244 has a structure of being likely to bend in the height direction Z, and strength to external force becomes lower. In contrast to this, in the connector 1 according to the present embodiment, by the lock member 24 being supported at three points, improvement in strength is achieved, and strength to external force can be improved.

The ends of the two arm portions 243 on the opposite side of the fitting surface 2A are respectively connected to the side walls 23. That is, the lock member 24 is supported on both sides corresponding to the fitting surface 2A side and the opposite side of the fitting surface 2A. Thus, the strength of the lock member 24 is improved as compared with a case of a cantilevered structure.

A recess portion 244A is formed in the installation portion 244. The recess portion 244A is formed by denting a surface of the installation portion 244 that faces the counterpart connector 10, along the connection direction X. For example, the recess portion 244A is formed by denting the entire installation portion 244 in the connection direction X. Here, the entire includes approximate entire. By the recess portion 244A being formed, the installation portion 244 of the lock member 24 has a structure less likely to receive external force. For example, even in a case where the connector 1 drops onto a floor, the installation portion 244 is unlikely to come into direct contact with a floor surface, and the lock member 24 has a structure less susceptible to impact.

As illustrated in FIGS. 1 to 3, the position assurance member 3 has a configuration in which a guide arm 32 and a lock arm 33 protrude from a base portion 31 toward the connection direction X. The base portion 31 is a plate-like portion erected upward, and provided toward a direction intersecting with the connection direction X. Two guide arms 32 are provided, and extend in the connection direction X from both ends in the width direction Y of the base portion 31. In a case where the position assurance member 3 is assembled to the assembling space 22 of the housing 2, the guide arm 32 is inserted along the guide portion 222.

The lock arm 33 is provided between the two guide arms 32 with protruding in the connection direction X. The lock arm 33 is an engagement portion that engages with the housing 2. In a case where the position assurance member 3 is assembled to the assembling space 22, the lock arm 33 is inserted between the two arm portions 243. In the lock arm 33, the lock portion 331 is formed. The lock portion 331 is a portion that engages with the locked portion 241 of the lock member 24 of the housing 2. In a case where the position assurance member 3 is inserted into the housing 2 up to a tentative lock position (standby position), the lock portion 331 is arranged at a position in front of the locked portion 241. In a case where the connector 1 is appropriately connected to the counterpart connector 10, the position assurance member 3 becomes insertable into the housing 2 up to a regular lock position, and it becomes possible to cause a user to recognize that the connector 1 is appropriately connected to the counterpart connector 10. At this time, by the insertion of the position assurance member 3, the lock portion 331 crawls under the locked portion 241 to become movable with respect to the locked portion 241 toward the fitting surface 2A side of the housing 2. On the other hand, in a case where the connector 1 is not appropriately connected to the counterpart connector 10, the position assurance member 3 cannot be inserted into the housing 2 up to the regular lock position. In other words, the lock portion 331 cannot crawl under the locked portion 241 to move toward the fitting surface 2A side of the locked portion 241.

As illustrated in FIG. 1, the counterpart connector 10 has a tubular shape, and has a configuration in which a facing surface 11 is opened and the connector 1 can be inserted into an internal space 12. On a ceiling surface of the internal space 12, a lock portion (not illustrated) is formed. The lock portion is a protruding portion that engages with the locked portion 241 of the lock member 24. By the locked portion 241 being locked to the lock portion, the connector 1 is prevented from being detached from the counterpart connector 10. In the internal space 12, a plurality of terminals (not illustrated) is provided.

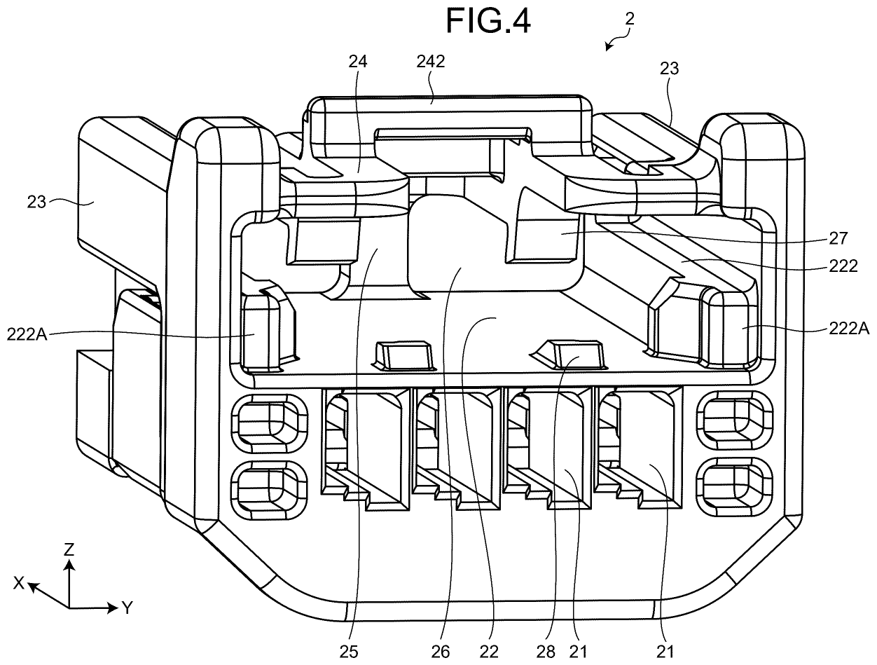

As illustrated in FIG. 4, in the lock member 24 of the housing 2, a protrusion portion 27 protruding downward from the arm portion 243 is formed. Further, a protrusion 28 protruding from the floor portion 221 of the assembling space 22 is formed. The protrusion portion 27 and the protrusion 28 are portions that engage with the position assurance member 3. In a case where the housing 2 is resin-molded, the connection direction X corresponds to a mold opening direction. In this case, when the protrusion portion 27 and the protrusion 28 are formed, for mold release, a hole 26 needs to be formed on the fitting surface 2A side of the assembling space 22. It is considered to open the entire portion on the fitting surface 2A side between the lock member 24 and the floor portion 221, but there is a concern that the support strength of the lock member 24 becomes lower. Thus, in the connector 1 according to the present embodiment, by supporting the lock member 24 by providing the columnar portion 25, the support strength of the lock member 24 is improved.

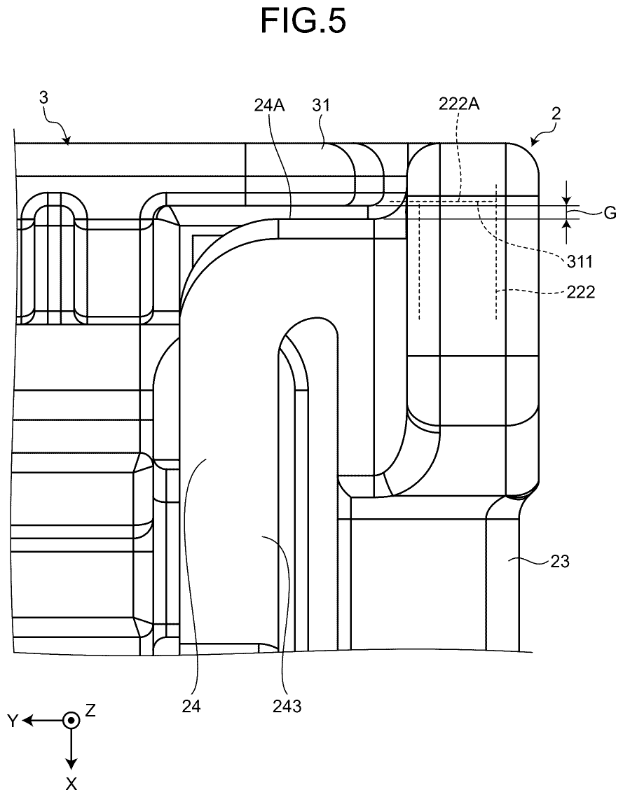

As illustrated in FIG. 5, the position assurance member 3 is assembled to the housing 2, and arranged at the regular lock position. At this time, the position assurance member 3 is separated from the lock member 24, and has contact with the end surface 222A of the guide portion 222. More specifically, the position assurance member 3 is inserted from the tentative lock position to the regular lock position in the assembling space 22, and by a contact surface 311 of the base portion 31 coming into contact with the guide portion 222, the position assurance member 3 is arranged at the regular lock position. At this time, the position assurance member 3 is separated from the lock member 24, and a clearance gap G is formed between the position assurance member 3 and the lock member 24.

Next, the mechanical strength of the connector 1 according to the present embodiment will be described.

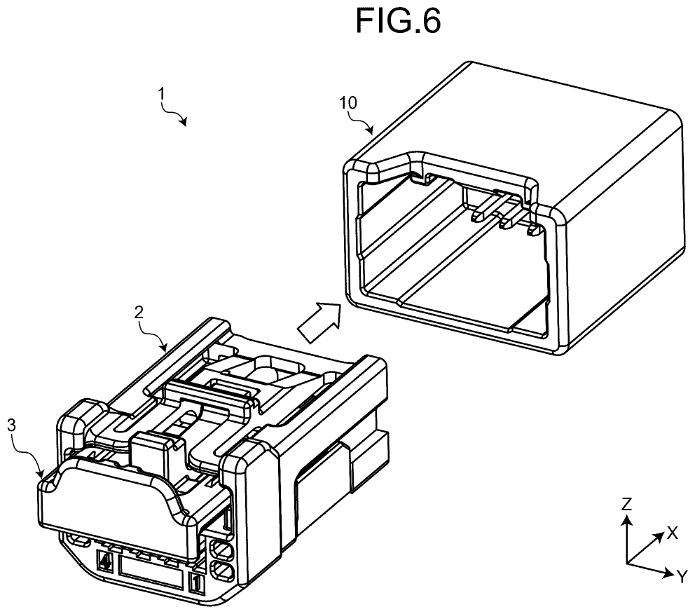

As illustrated in FIG. 6, the connector 1 is connected to the counterpart connector 10 by assembling the position assurance member 3 to the housing 2. The position assurance member 3 is inserted into the housing 2 up to the tentative lock position. An electric wire (not illustrated) is connected to the connector 1 and the counterpart connector 10.

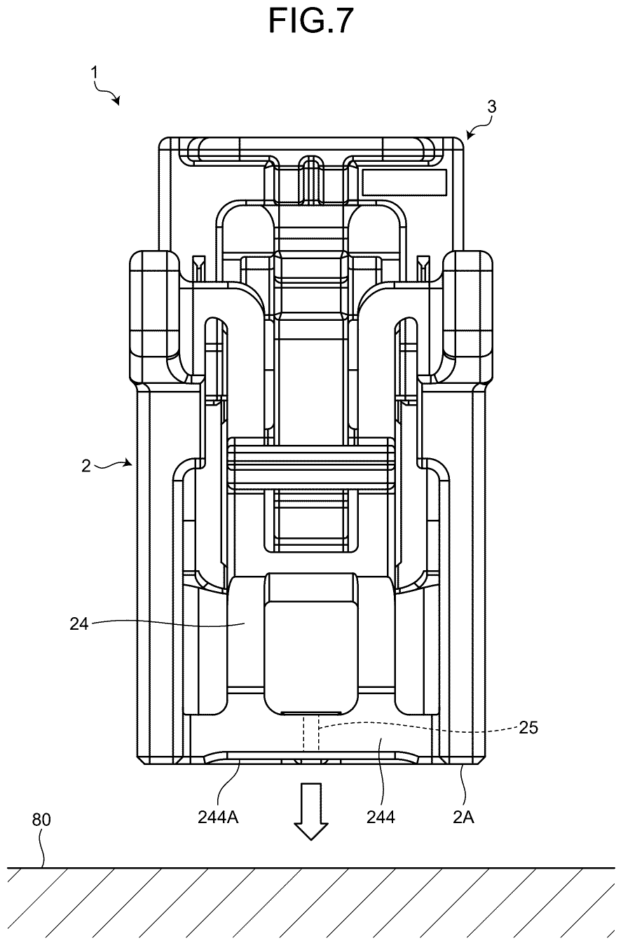

At this time, as illustrated in FIG. 7, the connector 1 sometimes bumps into an external object. For example, it is considered that the connector 1 erroneously drops and collides with a floor surface 80. In a case where the connector 1 drops with the fitting surface 2A being oriented downward, the fitting surface 2A collides with the floor surface 80. In this case, the connector 1 receives impact due to dropping, but large impact is prevented from being added to the lock member 24. That is, the recess portion 244A is formed in the installation portion 244 of the lock member 24, and the lock member 24 is provided with being recessed from the fitting surface 2A. Thus, in the connector 1 according to the present embodiment, the lock member 24 is prevented from coming into direct contact with the floor surface 80, and impact to be received from the floor surface 80 can be reduced.

Further, the lock member 24 is supported at three points in the housing 2, and mechanical strength is improved. That is, the installation portion 244 of the lock member 24 is connected with the side walls 23 on both sides, and connected with the columnar portion 25 extending from the floor portion 221 of the assembling space 22. Thus, the installation portion 244 has a structure difficult to move in the width direction Y and the height direction Z, and a structure less likely to deform in a case where impact is received. Accordingly, in the connector 1 according to the present embodiment, even in a case where impact is received from the floor surface 80, it is possible to prevent the lock member 24 from being easily broken.

Further, as illustrated in FIG. 5, in the connector 1, in a case where the position assurance member 3 is assembled to the housing 2 and is arranged at the regular lock position, the position assurance member 3 has contact with the guide portion 222 of the assembling space 22. At this time, the clearance gap G is formed between the position assurance member 3 and the lock member 24, and the position assurance member 3 is separated from the lock member 24. Thus, even in a case where the connector 1 comes into contact with an external object, direct impact is prevented from being added to the lock member 24. In other words, even if the position assurance member 3 of the connector 1 comes into contact with the external object, impact is transmitted to the guide portion 222 of the housing 2, and the impact is unlikely to be transmitted to the lock member 24. In the connector according to the present embodiment, external force is prevented from being added from the lock member 24, and bearing force for external force can be improved.

As described above, in the connector 1 according to the present embodiment, by the lock member 24 being supported at three points in the housing 2, the mechanical strength of the housing 2 can be improved. That is, in the housing 2, while the lock member 24 has a structure of being installed on the two side walls 23, the lock member 24 is connected with the two side walls 23 and the columnar portion 25, to be supported at three points. Thus, in the connector 1 according to the present embodiment, the lock member 24 can be strongly supported, and improvement in mechanical strength can be achieved.

Further, in the connector 1 according to the present embodiment, by forming the recess portion 244A in the installation portion 244 of the lock member 24, it is possible to prevent external force from being directly added to the lock member 24. With this configuration, in the connector 1 according to the present embodiment, it is possible to reduce impact to be added to the lock member 24.

Further, in the connector 1 according to the present embodiment, the position assurance member 3 is separated from the lock member 24 and brought into contact with the guide portion 222 at the regular lock position. Thus, in the connector 1 according to the present embodiment, in a case where the position assurance member 3 receives external force, it is possible to prevent external force from being transmitted to the lock member 24 via the position assurance member 3. Accordingly, the connector 1 according to the present embodiment can achieve improvement in mechanical strength.

In addition, the connector according to the present invention is not limited to the above-described embodiment, and various changes can be made within the scope set forth in the appended claims. The connector according to the present embodiment may be formed by appropriately combining the components of the above-described embodiment and a modified example.

For example, in the above-described embodiment, a case where the recess portion 244A is formed in the installation portion 244 has been described, but the recess portion 244A is not formed in the installation portion 244 in some cases. Even in this case, by supporting the lock member 24 at three points, it is possible to improve the strength of the connector 1.

According to the connector according to the present embodiment, it is possible to achieve improvement in strength.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing configured to be connectable to a counterpart connector, and form an assembling space along a connection direction; and
a position assurance member to be inserted into the assembling space and assembled to the housing in such a manner as to be movable along the connection direction from a tentative lock position to a regular lock position, wherein
the assembling space is formed between two side walls formed in the housing and extending in the connection direction,
the housing includes a lock member that engages with the position assurance member assembled to the assembling space, and locks the position assurance member at the regular lock position,
the lock member includes an installation portion installed between the two side walls, and
the installation portion is connected to the two side walls, and connected to a columnar portion extending from a floor portion of the assembling space, to be supported at three points.

2. The connector according to claim 1, wherein
the installation portion is provided on a side of a fitting surface of the housing that faces the counterpart connector, and a recess portion is formed by denting a surface facing the counterpart connector, along the connection direction.
